(19) United States
(12) Patent Application Publication
(10) Pub. No.: US 2008/0276420 A1
(43) Pub. Date: Nov. 13, 2008

(54) APPARATUS AND METHOD FOR CONNECTING DECORATED PANELS

(75) Inventor: Thomas A. Johnson, Sandy Hook, CT (US)

Correspondence Address: MCCORMICK, PAULDING & HUBER LLP, CITY PLACE II, 185 ASYLUM STREET, HARTFORD, CT, 06103, US

(73) Assignee: Wet Puppy Products, LLC, Sandy Hook, CT (US)

(21) Appl. No.: 11/746,105

(22) Filed: May 9, 2007

(51) Int. Cl. E05D 15/50

(52) U.S. Cl. 16/231

(57) ABSTRACT

A system for manually connecting decorated panels in a self-standing display. The panels have kerfs in the side edges and are decorated with photographic or graphic images that are sublimation printed on the panels. The panels are joined by inserting the leaves of hinges into the kerfs where they are held by friction fit. Hinges may be removed and additional panels added to augment the display.

This invention relates to decorated panels and to a system for connecting such panels together so that they will be self-supporting so as to enable viewing images that have been printed on or adhered to the panels.

### Background of the Prior Art

Traditionally, photographs and graphic images have been printed on a paper backing, inserted into picture frames, and protected with glass or plastic shields. The photographs or graphic images have usually been inserted into an open frame from the back and held by a backing member that is attached to the frame. This requires that the frame have a substantial thickness in order to accommodate the layers held within the frame opening.

Prior art picture frames have been fitted with various attachments, such as hooks, wires, magnets, or adhesive backing to enable suspending them from a vertical surface, or fitted with bases, stands, folding flaps, or hinges to enable them to stand and support themselves on a horizontal surface. The prior art abounds with double or triple, conventional picture frames fitted with hinges along the side edges that allow them to pivot so as to support themselves, while still allowing the pictures to be seen. The hinges have been attached by screws or pins passing through hinge leaves that are attached to the frames and that are exposed and unsightly.

Another way to display images or decorations is to print, laminate or otherwise adhere the images on flat panels having no inside openings.

Laminating, adhering, or printing photographs, artwork, or graphics onto thick substrates has been done for many years. Reasons for doing so include protecting images from damage, increasing their perceived value over products printed on paper, avoiding the expense or extra weight of traditional photo frames or glass, and making them more suitable for display on walls or horizontal surfaces.

Laminating requires close registration of the image with the substrate to avoid misalignment. An approach commonly used to overcome this is to make the photograph or laminate larger than the substrate and trim away the excess material after lamination. This process is costly from a labor perspective and can be dangerous if done manually because it requires the use of extremely sharp blades and significant pressure to cleanly cut through tough laminating films.

A further limitation of the lamination approach is that it is extremely challenging to laminate and trim photographs to fit substrates with complex perimeter shapes or curved contours.

Machines have been developed to automate the lamination of images onto rigid substrates of various thicknesses, trim away any excess laminate and shape and decorate the edges of the substrate with paint, foil, film, plastic laminate or other materials. Due to process requirements for applying these various edge treatments, machines of this type typically have significant limitations regarding the range of sizes, shapes, or thicknesses they can process, as well as requiring large capital investments to acquire. Changing from one workpiece to another can involve lengthy and expensive machine reconfiguration or the use of special fixtures and tooling. For companies that have already invested in capital-intensive printing or flat decorating equipment, buying additional equipment to shape and finish edges is undesirable.

Other processes besides lamination have also been historically used to decorate flat surfaces. Screen printing, painting, foil stamping, laser engraving, and pad printing are all used for imprinting text, graphics, and images directly onto thick substrates.

Digital printing systems called flatbed inkjet printers have recently been introduced that are capable of accurately printing photographs or graphics directly onto large sheets of thick substrates. Digital sublimation printing is also rapidly emerging as a viable technology for printing full color images onto a range of flat surfaces of varying thickness.

Sublimation printing is particularly useful as taught in U.S. Pat. No. 5,580,410 issued Dec. 3, 1996 to Johnston, U.S. Pat. No. 6,964,722 issued Nov. 15, 2005 to Taylor et al and U.S. Pat. No. 6,998,005 issued Feb. 14, 2006 to Magee et al, these being merely exemplary of the sublimation printing art. Use of sublimation printing creates the ability to obtain sharp full color photographs, text and graphic images on a wide variety of sublimatable substrates.

Newly available automated cutting machines are capable of recognizing graphics printed on large sheets and cutting them to any desired perimeter contour. These systems use computer-guided knives, lasers, or routers to perform the cutting operation depending on the composition and thickness of the substrate.

The effect of these new digital printing processes and automated cutting systems is to eliminate much of the manual labor associated with previous methods of printing, lamination and hand trimming.

Until recently, however, there still existed a major challenge for companies attempting to profitably increase the perceived value of text, photographs and graphics by digitally printing them onto thick substrates and using automated cutting machines to fabricate them into discreet products. The challenge involved managing the tradeoffs in cost, durability, and appearance characteristics of the available substrates.

Generally speaking, the lighter and less expensive a substrate is, the less durable and attractive it is as a surface for mounting photographs and graphics. The least expensive substrates tend to be foam core boards faced with paper. These boards exhibit unsightly edge porosity, are structurally weak and can be easily dented, creased, or damaged. The least expensive foam boards have white cores that are visible when a laminated photo assembly is viewed from the side, making it obvious how the photo was increased in thickness and eliminating much of the perceived value of the thicker mounting.

More expensive foam boards are denser and have colored or black cores, making them somewhat more durable and visually appealing, yet still demonstrating various degrees of edge porosity.

Eliminating edge porosity and increasing durability can be accomplished by using denser substrates that include plastic, solid wood, and a range of composite wood panels such as hardboard and medium density fiberboard.

Of all available substrates, hardboard and medium density fiberboard offer the most advantageous combination of low cost, durability, and a smooth surface for printing, coating or laminating. The major disadvantage of these two materials is their brown color, which is generally considered unattractive in its raw state.

A company called Universal Woods now offers a range of imprintable blank panel products with a proprietary sublimation coating marketed under the Unisub brand that helps printing companies improve the perceived value of text, photographs and graphics without the expense of traditional photo frames. These blanks provide a durable substrate for protecting images that is suitable for decoration by digital sublimation printing. They avoid the dangers and labor associated with manually trimming laminations and can be supplied in a wide range of complex or curved perimeter profiles so as to be printable without the use of specialized fixtures or tooling. The product line utilizes inexpensive substrates including hardboard and medium density fiberboard. The panel blanks are laser cut, which produces an attractive black edge that requires no further edge finishing. The exposed back surface of the panels is painted black to match the edges and to hide the undesirable brown substrate color.

Printing images and graphics onto thick substrates is one way to enhance their utility and perceived value. Another method of displaying photographs that increases their value is the use of multiple photo frames that allow a group of separate photographs to be displayed together in an attractive arrangement. While the Unisub sublimatable panel product line solves many of the previous challenges associated with printing and displaying text, images and graphics onto individual panels, it does not offer a way to connect these imprinted panels together to create multi-panel displays.

Heretofore, there has not been a satisfactory system for connecting together thin decorated panels, for example when two conventional picture frames are connected, the hinge leaves are exposed and the hinge pin protrudes outside of the frames. The hinged frames will generally only pivot toward one another in one direction. Attachment of hinges in this manner requires tools and poses the possibility of damage to the printed surfaces. If it is desired to add a new photograph in a third frame, tools are required to disassemble the display and to affix new hinges.

Hinges are known in the prior art, in which the hinge leaves are buried in a saw cut or kerf rather than being exposed. U.S. Pat. No. 1,660,266 issued Feb. 21, 1928 to Horner shows such a hinge, which is inserted at an angle into a kerf and held in place with filler strips smeared with glue. U.S. Pat. No. 1,551,501 issued Aug. 25, 1925 to Hurlburt discloses a hinge for a measuring rule in which the hinge leaves are disposed perpendicular to the hinge pin and buried in kerfs cut in the edge of the measuring rule and pinned in place. A hinge adapted for insertion into a semicircular kerf and having barbs struck out from the hinge leaves at an angle to resist removal from the kerf is commercially available, as manufactured and sold by Craft, Inc.

It would be desirable to have a system for connecting together thin decorated panels for displaying more than one such decorated panel as part of a self-standing display group, for connecting together such decorated panels without the use of tools, and for easily adding an additional such decorated panel to a display group.

It would also be desirable to provide decorated panels having uniformly arranged connection points that allow the panels to be connected together interchangeably after printing without the use of tools, and to allow the panels to be disconnected and reconnected without the use of tools to add another panel to the display.

It would also be desirable to have a system for connecting and disconnecting panels having imprintable surfaces.

Accordingly one object of the present invention is to provide a method and apparatus for connecting together imprintable or decorated panels.

Another object of the present invention is to provide a method and apparatus for displaying more than one decorated panel as part of a self-standing display group.

Another object of the present invention is to provide a method and apparatus for connecting or disconnecting decorated panels without the use of tools.

Another object of the present invention is to provide a method and apparatus for easily adding an additional printed panel to a display group.

Another object of the invention is to provide a method and apparatus for a self-standing display of panels having imprintable surfaces.

### SUMMARY OF THE INVENTION

Briefly stated, the invention comprises a method and apparatus for making a self-standing display for decorated flat panels. The apparatus comprises: at least two panels, each comprising a substrate of uniform thickness at least one of the panels having a planar front surface suitable for printing thereon or adhering printed images thereto, each panel having a planar side edge perpendicular to its front surface and a base perpendicular to its planar side edge, each planar side edge having at least one kerf cut into the substrate parallel to the planar front surface, and at least one hinge having a pair of opposed leaves, the opposed leaves being dimensioned and arranged to be inserted into the kerfs of two panels equidistant from the respective bases thereof, whereby the two panels may be pivoted on the hinge so as to enable the two panels to support one another on their bases. In the preferred embodiment, there are two hinge members each having interleaved barrel portions pivotable about a hinge pin with the barrel portions disposed between the side edges and each having leaves with protruding angled tabs to hold the leaves in the kerfs with a friction fit. The invention contemplates the provision of additional panels with kerfs cut into the side edges so that three or more panels may be joined.

The method comprises (1) providing a plurality of panels each comprising a substrate of uniform thickness at least one of the panels having a planar front surface suitable for printing thereon or adhering printed images thereto, each panel having a planar side edge perpendicular to its front surface and a base perpendicular to its planar side edge, (2) cutting kerfs into the substrate, the kerfs extending parallel to the planar front surface of each of the panels and located equidistant from the respective bases thereof, (3) decorating said planar surface of at least one of said panels with an image, (4) providing at least one hinge having a pair of opposed leaves, the opposed leaves being dimensioned and arranged to frictionally fit into the kerfs of two panels and (5) inserting the opposed leaves into the kerfs to assemble the display.

### DRAWING

Other objects and advantages of the invention will become apparent by reference to the following specification, taken in connection with the accompanying drawings, in which:

FIG. 1 is a front elevation view of two imprintable panels, each having images printed thereon and connected together at their adjoining side edges by hinges,

FIG. 2 is a top plan view of the panels of FIG. 1,

FIG. 3 is a top plan view of the panels of FIG. 2, but with the panels pivoted on the hinges so as to be self-supporting on a horizontal surface,

FIG. 4 is an enlarged top plan view of portions of FIG. 2 taken at the hinge area,

FIG. 5 is an enlarged top plan view of portions of FIG. 3 taken at the hinge area,

FIG. 6 is an enlarged side elevation view of the side edge near the base of an unassembled imprintable panel,

FIG. 7 is an enlarged front elevation view of the same portion of the unassembled imprintable panel, taken in section along lines VII-VII of FIG. 6, looking in the direction of the arrows,

FIG. 8 is an enlarged top plan view of portions of two assembled imprintable panels, taken in section along lines VIII-VIII of FIG. 9, looking in the direction of the arrows,

FIG. 9 is an enlarged top plan view of the same portions of two assembled imprintable panels, taken in section along lines IX-IX of FIG. 8, looking in the direction of the arrows,

FIG. 10 is a front elevation view of three assembled imprintable panels having images imprinted thereon, connected by hinges and pivoted in zig-zag fashion so as to be self-supporting on a horizontal surface,

FIG. 11 is a top elevation view of the assembled panels of FIG. 10,

FIG. 12 is a front elevation view of two assembled imprintable panels connected in “portrait” aspect with interrupted base edges,

FIG. 13 is a front elevation view of two assembled imprintable panels connected in “landscape” aspect, and

FIG. 14 a front elevation view of two assembled imprintable panels of different frontal size and shape connected along opposed side edges with a common size and shape.

### DETAILED DESCRIPTION OF THE PREFERRED EMBODIMENT

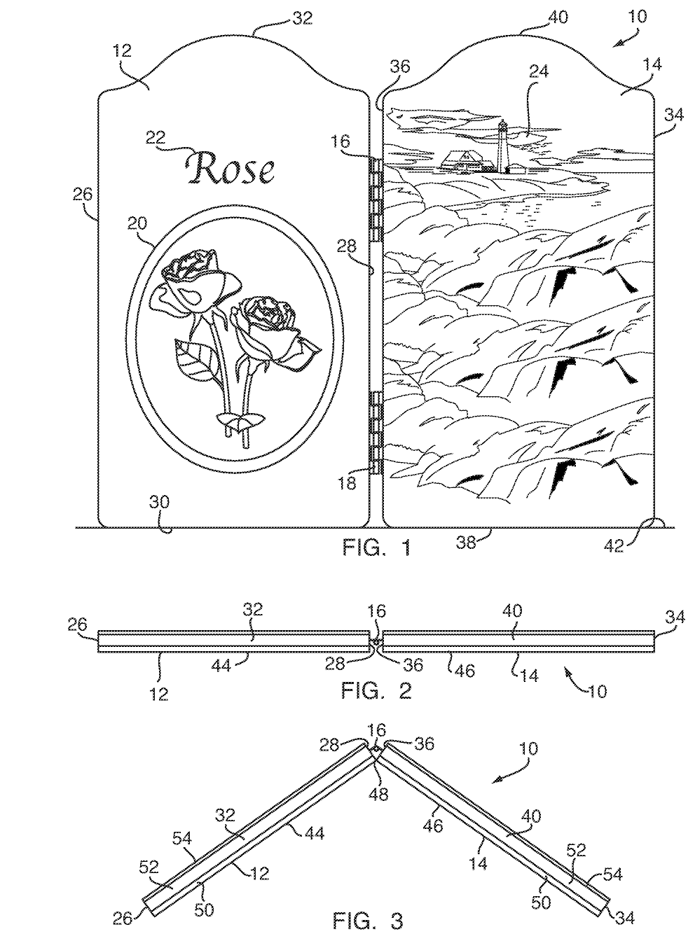

Referring now to FIGS. 1, 2 and 3 of the drawing, a self standing display is shown generally at 10 of a left imprintable panel 12 connected to a right imprintable panel 14 by a top hinge 16 and a bottom hinge 18. The left panel 12 has been imprinted with a photographic image 20 and text 22, while the right hand panel 14 has been imprinted with an image 24 covering the entire surface of the panel. The nature of the depicted images is immaterial to the present invention and can be graphic artwork, photographs, text, geometrical designs or any sort of image, either in color or black and white that can be applied directly by printing or which can be adhered to a planar surface, using known printing or decorating techniques. When speaking of an adhered image, I mean an image that has been previously printed or applied to a backing member such as paper, plastic film or other laminating film which is then adhered to the planar surface. In accordance with the preferred embodiment of the present invention, the sublimation printing process is used.

The left panel 12 has an exposed side edge 26, a connectable side edge 28, a base edge 30 and an arched top edge 32. The right panel 14 has an exposed side edge 34, a connectable side edge 36, a base edge 38 and an arched top edge 40. The two base edges 30,38 rest upon a horizontal surface 42.

Referring to FIG. 2, the plan view shows that the panels 12 and 14 are relatively thin, of uniform thickness and have smooth planar surfaces 44, 46 respectively for receiving the printed images. The edges of the panels 12 and 14 are laser cut resulting in a black finished edge.

Referring to FIG. 3, the panels 12 and 14 have been pivoted with respect to one another about hinges 16, 18 until they meet along the connectable edges and interfere with one another to prevent further pivoting. This point is indicated by reference number 48. A similar situation takes place when the panels are pivoted in the opposite direction, (not shown) and the panels interfere with one another to prevent further pivoting motion. The angular disposition of pivoted panels permits the display to be self-standing or self-supporting on the base edges of the panels as will be readily understood.

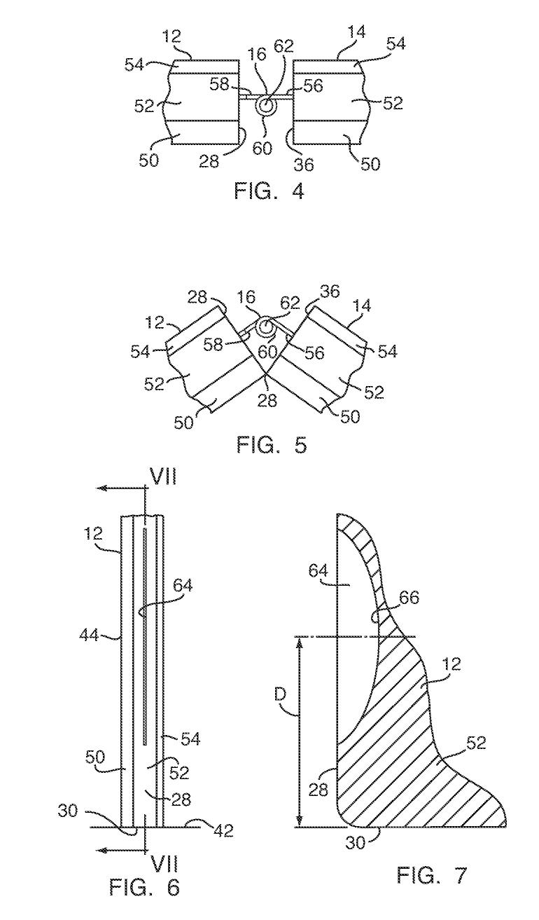

Referring to FIGS. 4 and 5 of the drawing, enlarged views of portions of panels 12 and 14 are shown. According to the preferred embodiment of the invention, the panels are imprintable by the sublimation printing process by virtue of having a sublimatable coating or layer 50 on top of the front surface of a substrate 52. An optional colored coating or sealing layer 54 is applied to the back surface to match the laser cut side edges, although this can be omitted if desired.

The substrate 52 may be a composition of cellulose or wood particles and resin binder which is commercially available and known in the trade as “hardboard”, preferably on the order of 0.25 inches (0.636 cm) thick. However, any substrate that is rigid, of uniform thickness with ability to be laser cut, machined or sawed and having a smooth planar surface suitable for printing or adhering images would be suitable. Also the thickness of the substrate may vary considerably from the preferred thickness, although thickness greater than 0.5 inches (1.27 cm) is not desirable, since this would restrict the opening angle.

The sublimatable coating 50 is one of many known polymeric coatings that will accept sublimation inks during a known printing process at elevated temperatures and which will adhere to the substrate 52. A suitable sublimatable coating is polyester, applied in a layer of approximately 0.004″ to 0.010″ thickness.

The upper hinge 16 is seen in FIGS. 4 and 5 to comprise hinge leaves 56 and 58 inserted into kerfs cut in the side edges 28, 36 of panels 12 and 14 as will be explained later. The hinge leaves are formed on their exposed outer sides with barrel portions, one of which is seen at 60. The barrel portions are interleaved in conventional fashion about a hinge pin 62. The barrel portions 60, in contrast to the prior art, are disposed between the side edges 28, 36. Because of this and because the leaves are held in kerfs cut into the side edges, the panels 12, 14 have a limited degree through which they can pivot on hinge 16 before interfering with one another at point 48. This adds to stability of the assembly as a self-standing display.

Referring now to FIGS. 6 and 7 of the drawing, there is shown an enlarged side elevation view and a front elevation view, in section, of the side edge 28 near the base edge 30 of an unassembled panel 12. A lower kerf 64 has been cut into the side edge 28 extending into substrate 52 generally perpendicular to the side edge and parallel to the imprintable layer 50. The shape of the kerf may be selected according to the shape of the hinge leaf to be contained therein and according to the type of cutting tool used to create the kerf. The preferred shape used in the present invention is a semi-circular shape bounded by the semi-circle 66, since this can be cut with a circular saw blade, using a fixture to hold the panel. Panel 14 is provided with a similar kerf (not shown). Both lower kerfs are identically dimensioned and located the same distance D (measured from the center) from the respective base edges. By this means, the bases of both panels will rest on the horizontal support surface 42 when the hinge is installed. Upper kerfs are also cut an identical distance from a suitable datum line, such as the base edge. By this means every left-hand panel will be interchangeable with every right hand panel.

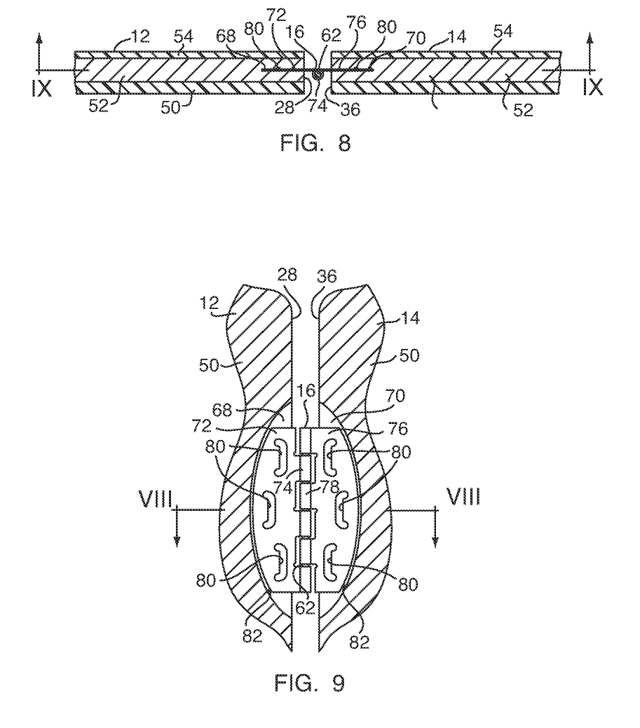

Reference to FIGS. 8 and 9 shows upper hinge 16 installed in panels 12 and 14. Upper semicircular kerfs 68 and 70 are cut into the side edges 28 and 36 respectively to accommodate the leaves of hinge 16. Hinge 16 has a left hand leaf 72 with curled barrel portions 74, and a right hand leaf 76 with curled barrel portions 78. The barrel portions 74, 78 are interleaved in conventional fashion to receive the hinge pin. The width of the kerfs 68, 70 and the thickness of leaves 72, 76 are pre-selected to provide a friction fit so that the hinge can be removed by force, but not so that it can become accidentally dislodged. In order to resist accidental dislodgment, tabs 80 that are inclined toward the kerf opening may be stamped in the leaves, as shown in the cross-section of FIG. 8.

It will further be noted that the leaves 72, 76 of hinge 16 are partially semicircular to match the shape of the kerf and also provide clearances 82 with the walls of the kerf. This allows a vertical adjustment to compensate for manufacturing variations.

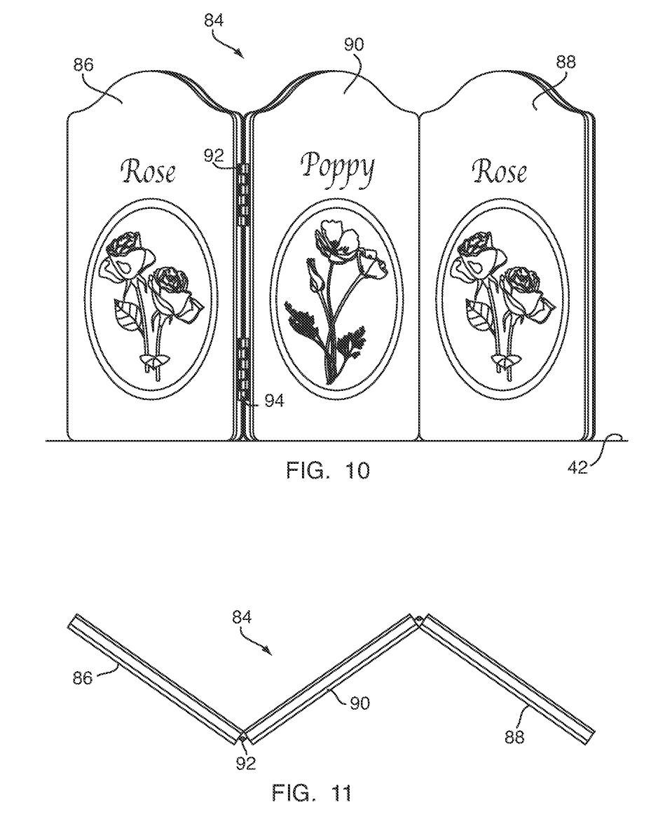

FIGS. 10 and 11 illustrate an extension to a self-standing three-panel display 84. Left-hand decorated panel 86 and right hand decorated panel 88 are made like the previously described panels 12 and 14. A center decorated panel 90 is provided with upper and lower semicircular kerfs having the identical shape and the identical placement, with respect to a datum line as do those in the left hand and right hand panels. Upper and lower hinges 92, 94, constructed as previously described are installed in the kerfs. FIG. 11 shows the panels pivoted in opposite directions to form a zigzag, self-standing assembly, but the three panels could also be pivoted into a convex or concave type self-standing display assembly. Also, more panels can be added to provide a display of three center panels in a line with two side panels at an angle. The base edges of the panels are disposed in a common plane and support the panels on the horizontal surface 42 when the panels are pivoted.

Additional panels (not shown) may be constructed that have kerfs in both side edges identical to those in panel 90, imprinted or otherwise decorated with images and then installed. Installation of an additional panel takes place by manually disconnecting one of the panels and then manually inserting hinge leaves in the kerfs and pressing the panels together. The clearances 82 allow the panels to be aligned by pressing the connected panels down on the horizontal support surface against their bases.

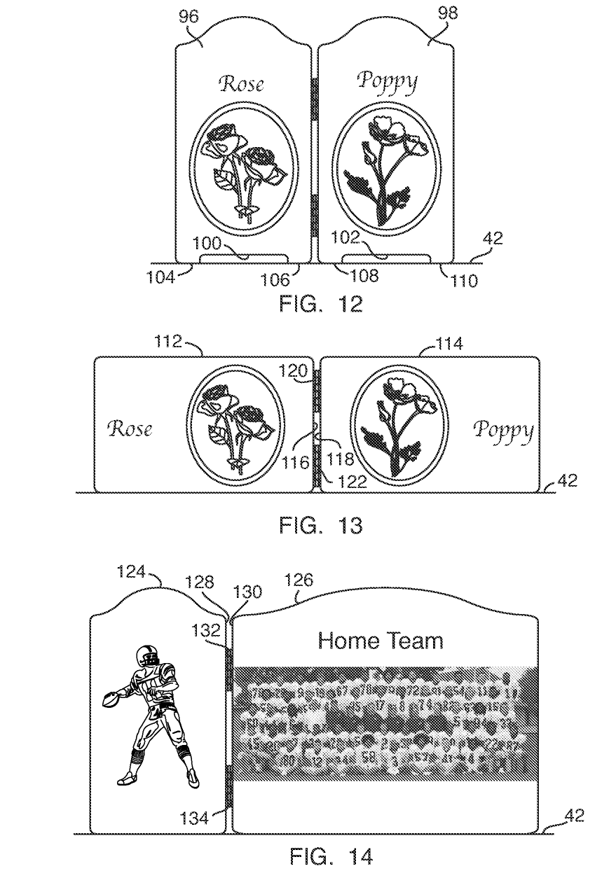

FIGS. 12, 13 and 14 show various modified shapes of decorated panels that can be used with the present invention. In FIG. 12, left and right panels 96 and 98 are joined by kerfed hinges as previously described. Rather than possessing continuous base edges, the panel bases are recessed at 100, 102. The bases comprise the end posts 104, 106, 108 and 110, which are disposed in a common plane and support the panels on the horizontal surface 42 when the panels are pivoted.

FIG. 13 illustrates decorated panels oriented in a “landscape” aspect rather than a “portrait” aspect, with the shorter side edges 116, 118 provided with kerfed hinges 120, 122 respectively. These are especially suitable for images of outdoor scenes or group photographs that are imprinted by a sublimation process directly on the panels.

FIG. 14 shows that the panels need not be the same size, as long as the common joining side edges are kerfed and hinged in the same way. A smaller panel 124 and a larger panel 126 are connected along their adjacent side edges 128, 130 respectively by kerfed hinges 132, 134 respectively. This self-standing display assembly is especially suitable for an athletic trophy with an individual photograph of the athlete imprinted on the small panel and a group photograph of the athlete's team imprinted on the large panel.

While there has been described what is considered to be the preferred embodiment of the invention and several modifications thereof, it is desired to secure in the appended claims all such modifications as fall within the true spirit and scope of the invention.

1. Apparatus for making a self-standing display of decorated panels comprising:
at least two panels, each said panel comprising a substrate of uniform thickness, at least one of said panels having a planar front surface suitable for printing thereon or adhering printed images thereto, each said panel having a planar side edge perpendicular to its respective said front surface, each said panel having a base perpendicular to its respective said planar side edge, each said planar side edge defining at least one kerf extending therefrom into its respective substrate parallel to the planar front surface thereof, and
at least one hinge having a pair of opposed leaves, said opposed leaves being dimensioned and arranged to be inserted into the kerfs of two panels equidistant from the respective bases, whereby said two panels may be pivoted on said hinge to enable said two panels to support one another on the respective bases thereof in a self-standing display.

2. Apparatus according to claim 1, wherein said opposed leaves each have barrel portions, said barrel portions being interleaved, a hinge pin extending through said interleaved barrel portions, said barrel portions being disposed between the respective side edges, whereby said panels may pivot with respect to one another in either direction.

3. Apparatus according to claim 2, wherein the hinge and panel are so dimensioned and arrange that pivoting of one panel with respect to the other panel is limited to an angle between said front surfaces of the panels of less than 90°.

4. Apparatus according to claim 1, wherein said opposed leaves each define at least one tab extending from the leaf and inclined toward the opening of said kerf so as to resist accidental dislodgment of said leaf.

5. Apparatus according to claim 1, wherein said kerf is semicircular.

6. Apparatus according to claim 5, wherein portions of said opposed leaves are semicircular.

7. Apparatus according to claim 1, wherein said planar front surface has an imprintable coating thereon.

8. Apparatus according to claim 7, wherein said imprintable coating is sublimatable, so as to be receptive to sublimation printing thereon.

9. Apparatus according to claim 7, wherein a photographic image is printed on said imprintable coating.

10. Apparatus according to claim 7, wherein text is printed on said imprintable coating.

11. Apparatus according to claim 7, wherein a graphic design is printed on said imprintable coating.

12. Apparatus according to claim 1, wherein said planar front surface has an image adhered thereto.

13. Apparatus according to claim 12, wherein said image is printed on a laminating film.

14. Apparatus according to claim 1, wherein there are at least three panels, at least a third one of said panels having first and second planar side edges perpendicular to its respective said front surface disposed on opposite sides of said third panel, said third panel defining at least a first kerf extending from the first planar side edge into the substrate parallel to the planar front surface thereof and at least a second kerf extending from the second planar side edge into the substrate parallel to the planar front surface thereof, whereby three or more panels may be connected to form a self-standing display.

15. Method for making a self-standing display for decorated panels comprising the steps of:
(a) providing a plurality of panels each comprising a substrate of uniform thickness, at least one of the panels having a planar front surface suitable for printing thereon or adhering an image thereto, each panel having a planar side edge perpendicular to its front surface and a base perpendicular to its planar side edge,
(b) cutting at least one kerf into each of said substrates, the kerfs extending parallel to the planar front surface of each of said panels and located equidistant from the respective bases thereof,
(c) decorating at least one of said panels by placing an image on said planar front surface,
(d) providing at least one hinge having a pair of opposed leaves, the opposed leaves being dimensioned and arranged to frictionally fit into the kerfs of two panels and,
(e) inserting the opposed leaves into the kerfs to assemble a self-standing display.

16. The process according to claim 15, wherein said decorating step comprises applying an imprintable coating to said planar front surface and printing an image on said imprintable coating.

17. The process according to claim 16, wherein said imprintable coating is receptive to sublimation printing thereon.

18. The process according to claim 15, wherein said decorating step comprises adhering a printed image to said planar front surface.

19. The process according to claim 15, wherein said decorating step comprises printing an image directly onto said planar front surface.
